(19) United States
(12) Patent Application Publication
(10) Pub. No.: US 2017/0310594 A1
(43) Pub. Date: Oct. 26, 2017

(54) EXPEDITED FABRIC PATHS IN SWITCH FABRICS

(71) Applicant: LinkedIn Corporation, Mountain View, CA (US)

(72) Inventors: Saikrishna Mangala Kotha, San Jose, CA (US); Shafagh Zandi, San Francisco, CA (US)

(73) Assignee: LinkedIn Corporation, Mountain View, CA (US)

(21) Appl. No.: 15/137,523

(22) Filed: Apr. 25, 2016

(51) Int. Cl. H04L 12/803; H04L 12/863; H04L 12/851; H04L 12/947; H04L/749

(52) U.S. Cl. CPC H04L 47/125; H04L 49/25; H04L 45/741; H04L 47/2483; H04L 47/50

(57) ABSTRACT

The disclosed embodiments provide a system for operating a switch fabric. During operation, the system identifies network traffic for transmission between two access switches in a switch fabric. Next, the system selects a subset of the network traffic for forwarding on an expedited fabric path comprising a physical link between the two access switches that isolated from other physical links in the switch fabric. Next, the system forwards the subset of the network traffic on the expedited fabric path.

### BACKGROUND

### Field

The disclosed embodiments relate to switch fabrics. More specifically, the disclosed embodiments relate to techniques for providing expedited fabric paths in switch fabrics.

### Related Art

Switch fabrics are commonly used to route traffic within data centers. For example, network traffic may be transmitted to, from, or between servers in a data center using an access layer of “leaf” switches connected to a fabric of “spine” switches. Traffic from a first server to a second server may be received at a first leaf switch to which the first server is connected, routed or switched through the fabric to a second leaf switch, and forwarded from the second leaf switch to the second server.

To balance load across a switch fabric, an equal-cost multi-path (ECMP) routing strategy may be used to distribute flows across different paths in the switch fabric. However, such routing may complicate visibility into the flows across the switch fabric, prevent selection of specific paths for specific flows, and result in suboptimal network link utilization when bandwidth utilization across flows is unevenly distributed.

### BRIEF DESCRIPTION OF THE FIGURES

FIG. 1 shows a switch fabric in accordance with the disclosed embodiments.

FIG. 2 shows an exemplary expedited fabric path in a switch fabric in accordance with the disclosed embodiments.

FIG. 3A shows an exemplary timeline of operations involved in using an expedited fabric path to forward network traffic in a switch fabric in accordance with the disclosed embodiments.

FIG. 3B shows an exemplary timeline of operations involved in using an expedited fabric path to forward network traffic in a switch fabric in accordance with the disclosed embodiments.

FIG. 3C shows an exemplary timeline of operations involved in using an expedited fabric path to forward network traffic in a switch fabric in accordance with the disclosed embodiments.

FIG. 4 shows a flowchart illustrating the process of operating a switch fabric in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

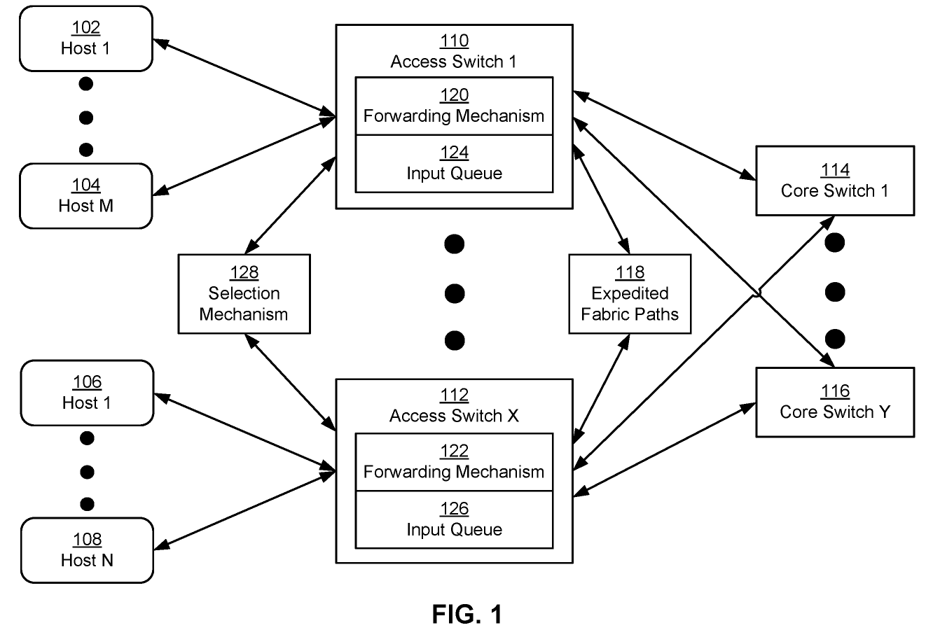

The disclosed embodiments provide a method, apparatus, and system for operating a switch fabric. More specifically, the disclosed embodiments provide a method, apparatus, and system for providing and using expedited fabric paths in switch fabrics. As shown in FIG. 1, a switch fabric may include a number of access switches (e.g., access switch 1 110, access switch x 112) connected to a set of core switches (e.g., core switch 1 114, core switch y 116) via a set of physical and/or logical links. For example, switches and/or other network nodes in the switch fabric may be connected in a leaf-spine topology, fat tree topology, mesh topology, “hypercube” topology, and/or other network topology.

The switch fabric may be used to route traffic to, from, or between nodes connected to the switch fabric, such as a set of hosts (e.g., host 1 102, host m 104) connected to access switch 1 110 and a different set of hosts (e.g., host 1 106, host n 108) connected to access switch x 112. For example, the switch fabric may include an InfiniB and (InfiniBand™ is a registered trademark of InfiniB and Trade Association Corp.), Ethernet, Peripheral Component Interconnect Express (PCIe), and/or other interconnection mechanism among compute and/or storage nodes in a data center. Within the data center, the switch fabric may route north-south network flows between external client devices and servers connected to the access switches and/or east-west network flows between the servers.

During routing of traffic through the switch fabric, the switches may use an equal-cost multi-path (ECMP) strategy and/or other multipath routing strategy to distribute flows across different paths in the switch fabric. For example, the switches may distribute load across the switch fabric by selecting paths for network flows using a hash of flow-related data in packet headers. However, conventional techniques for performing load balancing in switch fabrics may result in less visibility into flows across the network links, an inability to select specific paths for specific flows, and uneven network link utilization when bandwidth utilization is unevenly distributed across flows.

In one or more embodiments, the switch fabric of FIG. 1 includes functionality to improve routing of network traffic using one or more dedicated expedited fabric paths 118. Each expedited fabric path may include a physical link between a pair of access switches that is isolated from physical links connecting the access and core switches in the “non-expedited” switch fabric. For example, expedited fabric paths 118 may include a dedicated physical path between access switch 1 110 and access switch x 112 that does not connect to any of the core switches. Once a packet is placed on an expedited fabric path by an access switch, the packet may remain on the expedited fabric path until the packet exits the switch fabric. As a result, transmission of the packet on the expedited fabric path may be unaffected by network congestion in the “non-expedited” switch fabric.

More specifically, expedited fabric paths 118 may be used to perform end-to-end transmission of flows with high priority, latency sensitivity, and/or other identifiable or specified attributes. By physically separating such flows from other flows in the switch fabric, the transmission of the flows can be controlled and/or improved in a deterministic way, independently of the design or usage of the non-expedited switch fabric.

To identify network traffic for transmission on expedited fabric paths 118, a selection mechanism 128 may select or specify one or more attributes of the network traffic. A forwarding mechanism (e.g., forwarding mechanisms 120-122) in each access switch may use the specified attribute(s) to forward packets with parameters that match the attribute(s) onto dedicated ports connected to the expedited fabric paths. If multiple packets are to be transmitted on the expedited fabric path, the forwarding mechanism and/or access switch may place some or all of the packets in a dedicated input queue (e.g., input queues 124-126) for the expedited fabric paths until the packets can be forwarded on the expedited fabric paths.

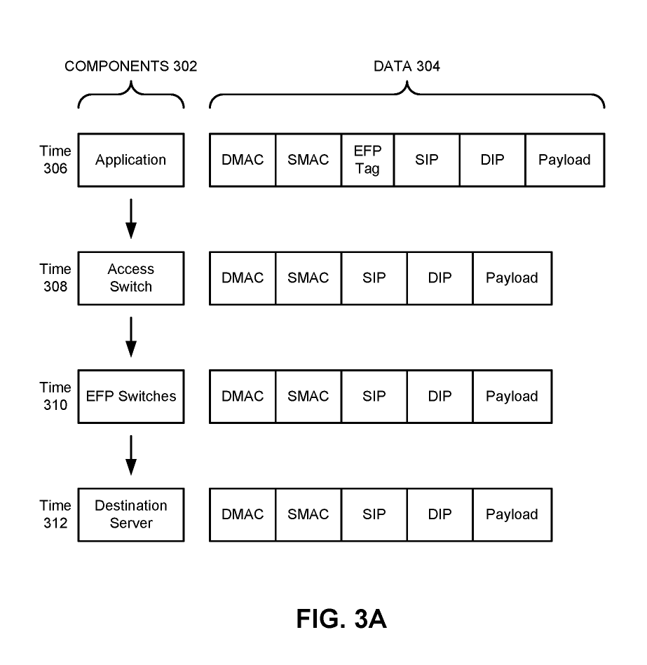

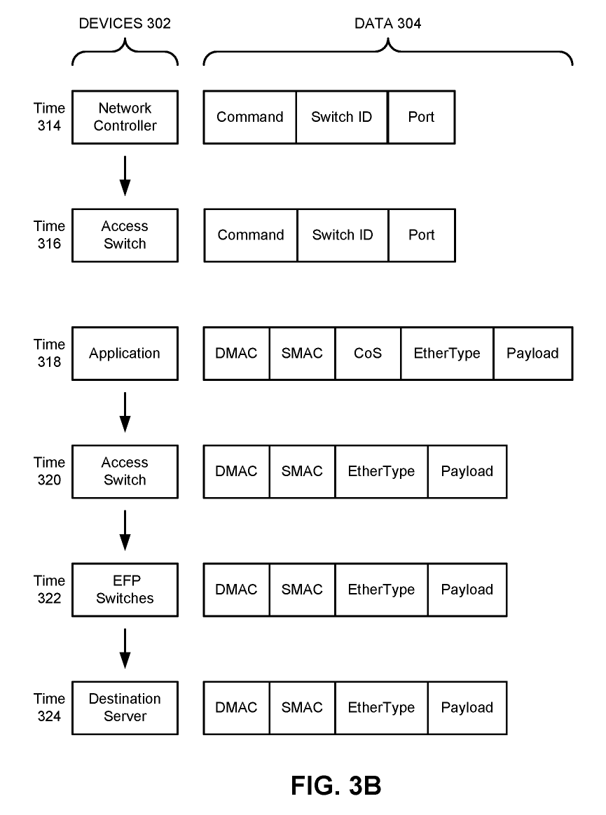

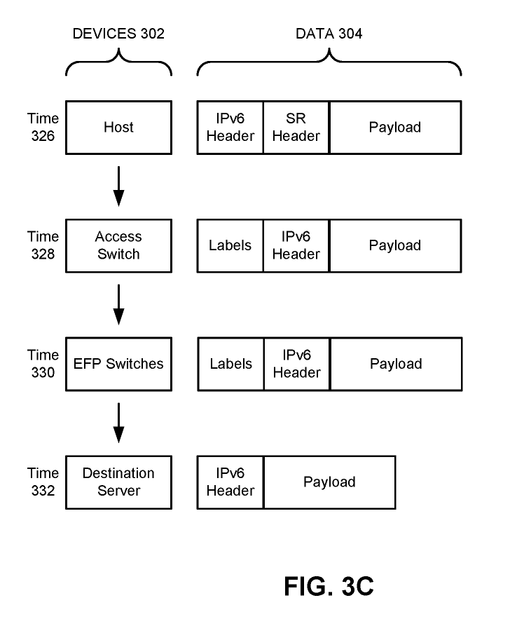

One or more hardware and/or software modules may be used to implement selection mechanism 128 and/or the forwarding mechanisms. First, a host connected to an access switch and/or an application executing on the host may request use of expedited fabric paths 118 from the access switch and/or another component of the switch fabric. If the request is approved, the component may update the forwarding mechanism of the access switch to forward network traffic from the host and/or application onto the expedited fabric paths. Alternatively, the host and/or application may insert a tag or label into packets for forwarding onto the expedited fabric paths. The access switch may process the tag or label and optionally determine if the packets meet other criteria for using the expedited fabric paths. If the criteria are met, the access switch may forward the packets onto the expedited fabric paths. Using applications or hosts to select network traffic for forwarding on expedited fabric paths is described in further detail below with respect to FIG. 3A.

Second, a network controller may implement selection mechanism 128 by providing, to access switches on expedited fabric paths 118, one or more rules for forwarding network traffic on the expedited fabric paths. Each rule may specify one or more attributes of the network traffic, such as a class of service (CoS), type of service (ToS), label, port, address, source, destination, and/or link aggregation group. For example, the network controller may generate an OpenFlow instruction containing a protocol, source Internet Protocol (IP) address, destination IP address, source port, and/or destination port associated with network flows to be transmitted on an expedited fabric path. One or more access switches on the expedited fabric path may receive the OpenFlow instruction and update their forwarding tables with the rule. Network traffic that matches the rule may then be forwarded onto the expedited fabric path by the access switch(es). By adding, removing, and/or modifying rules for using the expedited fabric paths, the network controller may dynamically manage the prioritization of network traffic in the switch fabric. Using a network controller to select network traffic for forwarding on expedited fabric paths is described in further detail below with respect to FIG. 3B.

Third, the application, host, network controller, and/or other component may use segment routing to forward network traffic onto expedited fabric paths 118. For example, a packet from the host may include an IPv6 header with a segment routing header extension that identifies one or more segments associated with an expedited fabric path. An access switch connected to the host may receive the packet, analyze the segment routing header extension, and use a forwarding table to determine that the packet is to be forwarded onto the expedited fabric path. The access switch may then replace the segment routing header extension with one or more Multiprotocol Label Switching (MPLS) labels, and the packet may be forwarded through the expedited fabric path to the packet's destination using the MPLS labels. Using segment routing to select network traffic for forwarding onto expedited fabric paths is described in further detail below with respect to FIG. 3C.

Those skilled in the art will appreciate that other criteria may be used by selection mechanism 128 and/or the forwarding mechanisms to forward network traffic onto expedited fabric paths 118. For example, the selection and/or forwarding mechanisms may move a portion of network traffic onto the expedited fabric paths when the non-expedited switch fabric experiences congestion. In another example, the selection and/or forwarding mechanisms may use attributes such as application type, application behavior, data types, file sizes, latency or performance metrics, scheduling, bandwidth usage, load-balancing parameters, and/or metadata to select network flows for transmission on the expedited fabric paths. Consequently, use of the expedited fabric paths may be adapted to different network topologies, types of network traffic, types of applications, types of data, and/or other characteristics of the switch fabric and/or nodes connected to the switch fabric.

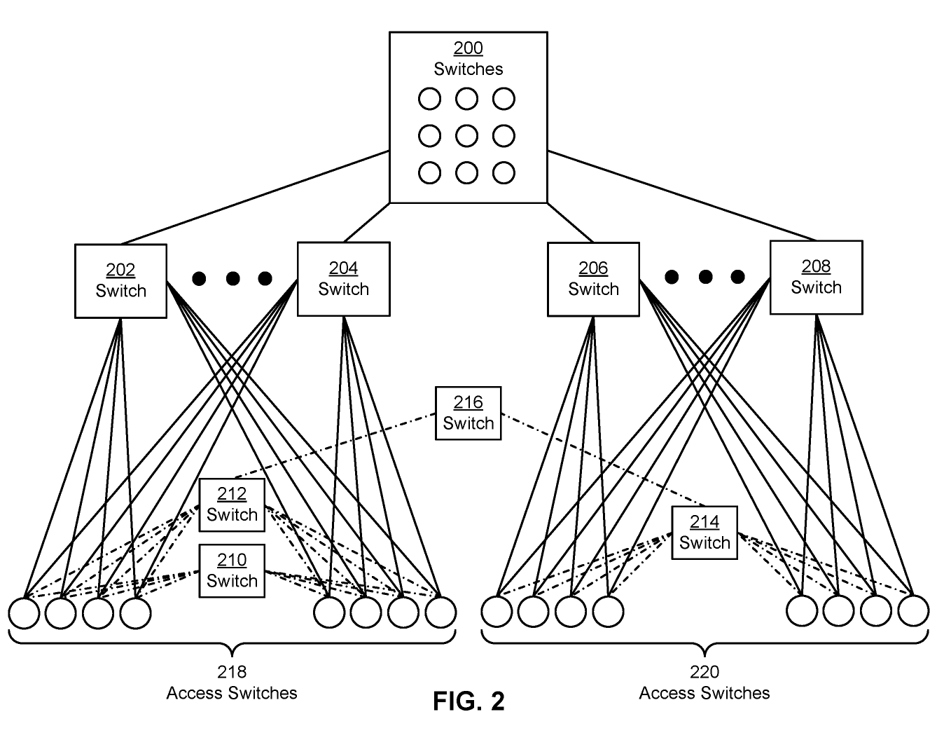

FIG. 2 shows an exemplary set of expedited fabric paths (e.g., expedited fabric paths 118 of FIG. 1) in a switch fabric in accordance with the disclosed embodiments. In the switch fabric of FIG. 2, one set of access switches 218 is connected to one set of switches 202-204, and a separate set of access switches 220 is connected to another set of switches 206-208. Switches 202-208 are then connected to a number of additional switches 200 to complete the switch fabric. As a result, forwarding of regular, “non-expedited” network traffic in the switch fabric may involve switches 200-208, access switches 218-220, and physical links that connect the switches (e.g. in a mesh).

For example, access switches 218 and switches 202-204 may form a “pod,” “cluster,” and/or another logical unit in a network. Similarly, access switches 220 and switches 206-208 may form a separate logical unit in the network. Each access switch may be a “top of rack” (ToR) switch, “end of row” switch, leaf switch, and/or another type of switch that provides connection points to the switch fabric for a set of hosts (e.g., servers, storage arrays, etc.). Switches 202-208 may be intermediate switches that connect the logical units with other parts of the switch fabric, and switches 200 may be spine switches, core switches, and/or other types of switches that route traffic across multiple logical units. Thus, network traffic may be transmitted within each logical unit using physical paths that involve the access and/or intermediate switches in the logical unit, while network traffic between logical units may be transmitted using switches 200 and a larger number of hops than network traffic within the logical units.

On the other hand, the expedited fabric paths may include a set of physical links that do not connect to switches 200-208. As shown in FIG. 2, the expedited fabric paths may include one set of connections between access switches 218 and a switch 210, a second set of connections between access switches 218 and a second switch 212, a third set of connections between access switches 220 and a third switch 214, and a fourth set of connections between switches 212-214 and switch 216. As a result, switches 210-216 may be expedited fabric path switches that, together with access switches 218-220, forward network traffic on dedicated, physically separate expedited fabric paths instead of over physical links in the regular, “non-expedited” switch fabric.

Because the expedited fabric paths are physically isolated from “non-expedited” network traffic in the switch fabric, network flows may be transmitted over the expedited fabric paths without being affected by the routing or transmission of other network flows on the “non-expedited” switch fabric. For example, expedited network traffic between access switches 218 may be forwarded using one or both switches 210-212, expedited network traffic between access switches 220 may be forwarded using switch 214, and expedited network traffic between a switch in access switches 218 and a switch in access switches 220 may be forwarded using switches 212, 216, and 214. Once a packet is selected for transmission on an expedited fabric path, the packet must remain in the expedited fabric path until the packet reaches the access switch connected to the packet's destination host. As a result, the performance of network flows on the expedited fabric paths may be guaranteed even when flows on other physical links in the switch fabric experience congestion.

Those skilled in the art will appreciate that the expedited fabric paths may be configured in other ways. For example, additional physical links within the same logical unit may be added to the expedited fabric paths by connecting access switches (e.g., access switches 218 and 220) in the logical unit to one or more expedited fabric path switches (e.g., switches 210, 212 and 214) within the logical unit. Additional physical links between logical units may, in turn, be added to the expedited fabric paths by connecting the expedited fabric path switches within the logical units to one another using one or more additional expedited fabric path switches (e.g., switch 216).

FIG. 3A shows an exemplary timeline of operations involved in using an expedited fabric path to forward network traffic in a switch fabric in accordance with the disclosed embodiments. As shown in FIG. 3A, a number of components 302 connected to the switch fabric may transmit data 304 that is used to select the expedited fabric path for the network traffic and forward the network traffic on the expedited fabric path. At time 306, an application transmits a packet containing a destination Media Access Control (MAC) address (i.e., “DMAC”), a source MAC address (i.e., “SMAC), an expedited fabric path tag (i.e., “EFP Tag”), a source IP address (i.e., “SIP”), a destination IP address (i.e., “DIP”), and a payload. The expedited fabric path tag may be a parameter in the packet that represents a request to transmit the packet on the expedited fabric path.

At time 308, an access switch connected to the application receives the packet, identifies the expedited fabric path tag in the packet, and removes the expedited fabric path tag from the packet. The access switch may use the tag and/or other criteria (e.g., network conditions, protocol, packet type, source or destination port, source or destination address, etc.) to select the packet for forwarding on the expedited fabric path. At time 310, the packet is transmitted over the expedited fabric path using a set of expedited fabric path switches (i.e., “EFP Switches”). Because the tag is removed from the packet and the expedited fabric path is physically separate from other physical links in the switch fabric, the expedited fabric path switches may use conventional protocols and mechanisms to forward the packet along the expedited fabric path. In other words, only the access switch may be required to have knowledge of the expedited fabric path and select packets for forwarding on the expedited fabric path. At time 312, the packet is received at the destination server represented by the destination IP and/or MAC addresses.

FIG. 3B shows an exemplary timeline of operations involved in using an expedited fabric path to forward network traffic in a switch fabric in accordance with the disclosed embodiments. At time 314, a network controller provides a rule for forwarding a subset of network traffic on the expedited fabric path. The rule may include a command, a switch ID, and a port. For example, the command may include a “set-get-update” from the network controller, and the switch ID and port may define a CoS. At time 316, an access switch with the switch ID in the switch fabric receives the rule and updates a CoS forwarding table with the parameters of the rule.

At time 318, an application transmits a packet containing a destination MAC address, a source MAC address, the CoS in an 802.1Q header, an EtherType field, and a payload. At time 320, the access switch receives the packet, identifies the header containing the CoS, and removes the header from the packet. The access switch may match the contents of the header to the rule and select the packet for forwarding on the expedited fabric path. At time 322, the packet is transmitted over the expedited fabric path using a set of expedited fabric path switches. At time 324, the packet is received at the destination server represented by the destination MAC address.

FIG. 3C shows an exemplary timeline of operations involved in using an expedited fabric path to forward network traffic in a switch fabric in accordance with the disclosed embodiments. At time 326, a host and/or an application in the host transmits a packet with an IPv6 header, a segment routing header (i.e., “SR Header”), and a payload. The segment routing header may contain one or more segments that identify the expedited fabric path for routing of the packet.

At time 328, an access switch connected to the host receives the packet, identifies the segment routing header in the packet, and removes the segment routing header from the packet. The access switch may use an IPv6 forwarding table and the segment routing header to decide to forward the packet on the expedited fabric path. Prior to forwarding the packet, the access switch converts the segments from the segment routing header into a stack of one or more MPLS labels at the front of the packet. As a result, the access switch may switch from IPv6 segment routing, which is commonly available on hosts but has high packet header overhead, to MPLS segment routing, which has lower packet header overhead and is commonly available on switches.

At time 330, the packet is transmitted over the expedited fabric path using a set of expedited fabric path switches. As the packet completes a segment represented by the topmost label in the stack, an expedited fabric path switch at the end of the segment may remove the label from the stack, identify the next segment represented by the new topmost label, and forward the packet onto the next segment. At time 332, after all labels have been removed from the stack, the packet is received at the destination server indicated in the IPv6 header.

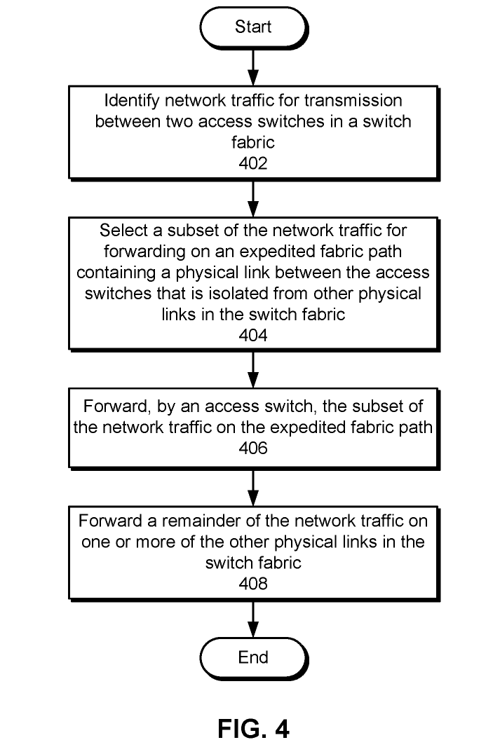

FIG. 4 shows a flowchart illustrating the process of operating a switch fabric in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, network traffic for transmission between two access switches in a switch fabric is identified (operation 402). For example, the network traffic may be identified based on packet attributes such as labels, CoS, ToS, source and/or destination port, source and/or destination address, and/or link aggregation group. The network traffic may be identified by a host, network controller, and/or switch in the switch fabric.

Next, a subset of the network traffic is selected for forwarding on an expedited fabric path containing a physical link between the access switches that is isolated from other physical links in the switch fabric (operation 404). For example, the expedited fabric path may include one or more expedited path switches that are connected to the access switches and/or other expedited fabric path switches in the expedited fabric path but not other switches in a “non-expedited” portion of the switch fabric. Multiple expedited path switches may also be connected with one another and/or the access switches to create multiple expedited fabric paths in the switch fabric while maintaining isolation of the expedited fabric paths from the “non-expedited” paths in the switch fabric.

During selection of the subset of network traffic for forwarding in the expedited fabric path, a rule for forwarding the subset of network traffic on the expedited fabric path may be received from a network controller for the switch fabric. The rule may include one or more of the packet attributes and/or other criteria for selecting packets or flows for forwarding on the expedited fabric path.

The selection may alternatively or additionally include receiving, from a host connected to the access switch, a request to forward the subset of network traffic from the host on the expedited fabric path. The request may be made in the form of a handshake between the host and access switch, a tag in packets from the host, and/or another communication mechanism between the host and access switch.

The selection may further, or instead, include matching, at the access switch, a parameter in the subset of network traffic to an entry in a forwarding table for forwarding the subset of network traffic on the expedited fabric path and/or removing the parameter from packets prior to forwarding the packets on the expedited fabric path. The parameter may include a CoS, tag, segment routing information, and/or other metadata in the packets.

The subset of network traffic is then forwarded by an access switch on the expedited fabric path (operation 406). For example, a packet from a flow that is selected for forwarding on the expedited fabric path may be placed in a dedicated input queue for the expedited fabric path until the packet can be transmitted from a port connected to the expedited fabric path. The packet may then be routed over the expedited fabric path by one or more expedited fabric path switches until the packet reaches its destination and/or exits the switch fabric.

Finally, a remainder of the network traffic is forwarded on one or more other physical links in the switch fabric (operation 408). For example, network traffic that is not selected for forwarding on the expedited fabric path may be routed through “non-expedited” physical links and/or switches in the switch fabric.

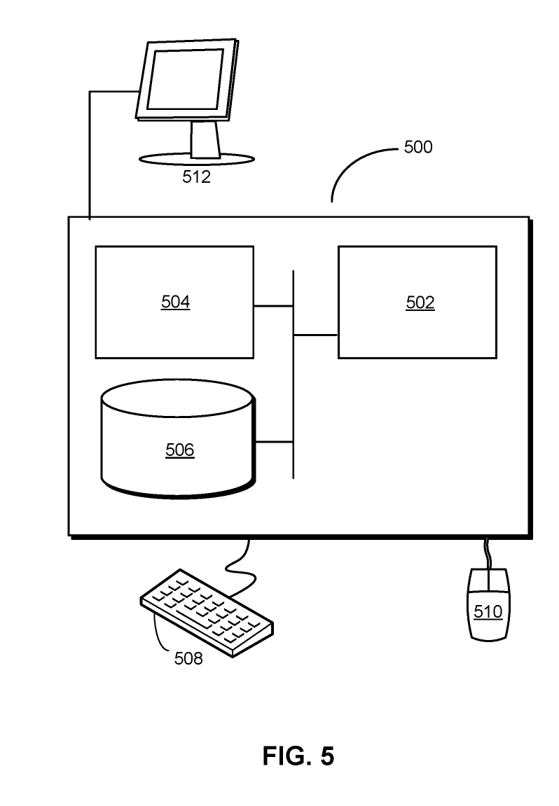

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for operating a switch fabric. The system may include a selection mechanism that identifies network traffic for transmission between two access switches in a switch fabric. Next, the selection mechanism may select a subset of the network traffic for forwarding on an expedited fabric path comprising a physical link between the two access switches that isolated from other physical links in the switch fabric. The system may also include a forwarding mechanism that forwards the subset of the network traffic on the expedited fabric path.

In addition, one or more components of computer system 500 may be remotely located and connected to the other components over a network. Portions of the present embodiments (e.g., switch fabric, expedited fabric path, selection mechanism, forwarding mechanism, switches, etc.) may also be located on different nodes of a distributed system that implements the embodiments. For example, the present embodiments may be implemented using a cloud computing system that selects network flows for forwarding on expedited fabric paths of a remote switch fabric based on attributes of the network flows.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A switch fabric, comprising:
a set of network switches connected by a set of physical links;
an expedited fabric path comprising an additional physical link between two access switches in the set of network switches that is isolated from the set of physical links; and
a selection mechanism that selects a subset of network traffic for forwarding on the expedited fabric path based on an attribute of the network traffic.

2. The switch fabric of claim 1, wherein the selection mechanism comprises:
a network controller that provides, to at least one of the two access switches, a rule for forwarding the subset of network traffic on the expedited fabric path.

3. The switch fabric of claim 2, wherein the rule comprises at least one of:
a class of service;
a type of service;
a label;
a port;
an address;
a source;
a destination; and
a link aggregation group.

4. The switch fabric of claim 1, wherein:
the selection mechanism comprises a host connected to one of the two access switches, and
the attribute comprises:
a first segment encoded in a packet from the host to the access switch; and
a second segment encoded in the packet from the access switch to the expedited fabric path.

5. The switch fabric of claim 4, wherein:
the first segment comprises an Internet Protocol version 6 (IPv6) segment, and
the second segment comprises a Multiprotocol Label Switching (MPLS) segment.

6. The switch fabric of claim 1, further comprising:
a forwarding mechanism in at least one of the two access switches, wherein the forwarding mechanism is configured to forward the subset of network traffic from the application on the expedited fabric path when a parameter in the subset of network traffic matches the attribute.

7. The switch fabric of claim 6, wherein the forwarding mechanism is further configured to:
remove the parameter from packets in the subset of network traffic prior to forwarding the packets on the expedited fabric path.

8. The switch fabric of claim 1, wherein the expedited fabric path further comprises one or more expedited fabric path switches between the pair.

9. The switch fabric of claim 1, wherein the additional physical link connects a first access switch and a second access switch within a logical unit of a network.

10. The switch fabric of claim 1, wherein the additional physical link connects a first access switch in a first logical unit of a network and a second access switch in a second logical unit of the network.

11. A method, comprising:
identifying network traffic for transmission between two access switches in a switch fabric;
selecting a subset of the network traffic for forwarding on an expedited fabric path comprising a physical link between the two access switches that is isolated from other physical links in the switch fabric; and
forwarding, by an access switch in the two access switches, the subset of the network traffic on the expedited fabric path.

12. The method of claim 11, further comprising:
forwarding a remainder of the network traffic on one or more of the other physical links in the switch fabric.

13. The method of claim 11, wherein selecting the subset of the network traffic for forwarding on the expedited fabric path comprises:
receiving, by the access switch from a network controller, a rule for forwarding the subset of network traffic on the expedited fabric path.

14. The method of claim 13, wherein the rule comprises at least one of:
a class of service;
a type of service;
a label;
a port;
an address;
a source;
a destination; and
a link aggregation group.

15. The method of claim 11, wherein selecting the subset of the network traffic for forwarding on the expedited fabric path comprises:
receiving, from a host connected to the access switch, a request to forward the subset of the network traffic from the host on the expedited fabric path.

16. The method of claim 11, wherein selecting the subset of the network traffic for forwarding on the expedited fabric path comprises:
matching, at the access switch, a parameter in the subset of the network traffic to an entry in a forwarding table for forwarding the subset of the network traffic on the expedited fabric path.

17. The method of claim 11, wherein selecting the subset of the network traffic for forwarding on the expedited fabric path comprises:
identifying, at the access switch, a parameter in the subset of the network traffic for forwarding the subset of the network traffic on the expedited fabric path; and
removing the parameter from packets in the subset of network traffic prior to forwarding the packets on the expedited fabric path.

18. The method of claim 11, wherein forwarding the subset of the network traffic on the expedited fabric path comprises:
placing a packet from the subset of the network traffic in a dedicated input queue for the expedited fabric path.

19. An apparatus, comprising:
one or more processors; and
memory storing instructions that, when executed by the one or more processors, cause the apparatus to:
identify network traffic for transmission between two access switches in a switch fabric;
select a subset of the network traffic for forwarding on an expedited fabric path comprising a physical link between the two access switches that isolated from other physical links in the switch fabric; and
forward the subset of the network traffic on the expedited fabric path.

20. The apparatus of claim 19, wherein forwarding the subset of the network traffic on the expedited fabric path comprises:
placing a packet from the subset of the network traffic in a dedicated input queue for the expedited fabric path.
